(19) United States
(12) Patent Application Publication
(10) Pub. No.: US 2006/0282221 A1
(43) Pub. Date: Dec. 14, 2006

(54) Automatic array quality analysis

(76) Inventors: Manish M. Shah, San Jose, CA (US); James S. Gruneisen, Palo Alto, CA (US); Luc Vincent, Palo Alto, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/148,626

(22) Filed: Jun. 9, 2005

(51) Int. Cl. G06F 19/00; G06K 9/00

(52) U.S. Cl. 702/19; 382/128

(57) ABSTRACT

Systems, methods and computer readable media for automatically inspecting a chemical array. At least one processor is adapted to receive a digitized image of the chemical array, and at least one of hardware, software and firmware are adapted to quantify at least one visual characteristic of a feature on the chemical array that contributes to uniformity of the visualization of the feature. Systems, methods and computer readable media are provided for automatically quantifying a visual characteristic of a chemical array. A digitized image of a chemical array having at least one feature is received, and at least one visual characteristic of a feature on the chemical array that contributes to uniformity of the visualization of the feature automatically quantified. A result based on the automatically quantification processing may be outputted to quantify at least one visual characteristic of a feature.

### BACKGROUND OF THE INVENTION

Array assays between surface bound binding agents or probes and target molecules in solution are used to detect the presence of particular biopolymers. The surface-bound probes may be oligonucleotides, peptides, polypeptides, proteins, antibodies or other molecules capable of binding with target molecules in solution. Such binding interactions are the basis for many of the methods and devices used in a variety of different fields, e.g., genomics (in sequencing by hybridization, SNP detection, differential gene expression analysis, comparative genomic hybridization, identification of novel genes, gene mapping, finger printing, etc.) and proteomics.

One typical array assay method involves biopolymeric probes immobilized in an array on a substrate such as a glass substrate or the like. A solution containing analytes that bind with the attached probes is placed in contact with the array substrate, covered with another substrate such as a coverslip or the like to form an assay area and placed in an environmentally controlled chamber such as an incubator or the like. Usually, the targets in the solution bind to the complementary probes on the substrate to form a binding complex. The pattern of binding by target molecules to biopolymer probe features or spots on the substrate produces a pattern on the surface of the substrate and provides desired information about the sample. In most instances, the target molecules are labeled with a detectable tag such as a fluorescent tag or chemiluminescent tag. The resultant binding interaction or complexes of binding pairs are then detected and read or interrogated, for example by optical means, although other methods may also be used. For example, laser light may be used to excite fluorescent tags, generating a signal only in those spots on the biochip (substrate) that have a target molecule and thus a fluorescent tag bound to a probe molecule. This pattern may then be digitally scanned for computer analysis.

As such, optical scanners play an important role in many array based applications. Optical scanners act like a large field fluorescence microscope in which the fluorescent pattern caused by binding of labeled molecules on the array surface is scanned. In this way, a laser induced fluorescence scanner provides for analyzing large numbers of different target molecules of interest, e.g., genes/mutations/alleles, in a biological sample.

Scanning equipment used for the evaluation of arrays typically includes a scanning fluorometer. A number of different types of such devices are commercially available from different sources, such as Perkin-Elmer, Agilent Technologies, Inc., Axon Instruments, and others. In such devices, a laser light source generates a collimated beam. The collimated beam is focused on the array and sequentially illuminates small surface regions of known location on an array substrate. The resulting fluorescence signals from the surface regions are collected either confocally (employing the same lens to focus the laser light onto the array) or off-axis (using a separate lens positioned to one side of the lens used to focus the laser onto the array). The collected signals are then transmitted through appropriate spectral filters, to an optical detector. A recording device, such as a computer memory, records the detected signals and builds up a raster scan file of intensities as a function of position, or time as it relates to the position.

Analysis of the data (the stored file) may involve collection, reconstruction of the image, feature extraction from the image and quantification of the features extracted for use in comparison and interpretation of the data. Where large numbers of array files are to be analyzed, the various arrays from which the files were generated upon scanning may vary from each other with respect to a number of different characteristics, including the types of probes used (e.g., polypeptide or nucleic acid), the number of probes (features) deposited, the size, shape, density and position of the array of probes on the substrate, the geometry of the array, whether or not multiple arrays or subarrays are included on a single slide and thus in a single, stored file resultant from a scan of that slide, etc.

In order to produce reliable experiments, microarrays must pass certain quality control standards prior to being hybridized, to ensure that the features of the array are of sufficient uniformity, shape and size to not interfere with the production of reliable results. After hybridization, the features are typically again inspected for quality control to ensure that the hybridized features meet or exceed quality standards so as not to interfere with the reliability of the data to be taken therefrom.

Microarray quality cannot be completely automatically evaluated by current methods and thus manual visual inspections of arrays must be carried out during a portion of quality control inspection procedures, to determine whether a microarray is of sufficient quality to be passed on to a customer to be hybridized and used to generate data. Furthermore, the end users of such microarrays also include a visual inspection portion of a quality control inspection procedure in order to determine whether the features on a microarray, after having been hybridized, are of sufficient quality for use in generating data that can be relied upon. Thus, every feature on an array is typically visually checked at least twice to identify visual defects in feature non-uniformity. These visual checks are costly and time-consuming, keeping the cost of array production high. Additionally, bias is introduced to the inspection process, since the various human inspectors will have various subjective standards by which they pass or fail a microarray, and even the standards for one inspector may vary depending upon human conditions such as fatigue, boredom, etc.

It would be desirable to automate visual inspections for determining the quality of features formed on an array, either pre- or post hybridization. It would be desirable to reduce the overall cost of microarray production. It would further be desirable to reduce bias as much as possible from processes for inspecting microarrays. Still further, it would be desirable to increase the rate at which microarrays may be visually inspected.

### SUMMARY OF THE INVENTION

Systems, methods and computer readable media for automatically inspecting a chemical array. At least one processor is adapted to receive a digitized image of the chemical array, and at least one of hardware, software and firmware are adapted to quantify at least one visual characteristic of a feature on the chemical array that contributes to uniformity of the visualization of the feature.

Systems, methods and computer readable media are provided for automatically quantifying a visual characteristic of a chemical array. A digitized image of a chemical array having at least one feature is received, and at least one visual characteristic of a feature on the chemical array that contributes to uniformity of the visualization of the feature automatically quantified. A result based on the automatically quantification processing may be outputted to quantify at least one visual characteristic of a feature.

Forwarding, transmitting and/or receiving a result obtained from any of the methods described herein are also disclosed.

These and other advantages and features of the invention will become apparent to those persons skilled in the art upon reading the details of the systems, methods and computer readable media as more fully described below.

### BRIEF DESCRIPTION OF THE DRAWINGS

FIG. 1A is a flow chart indicating automated processes that may be carried out for automatic visual inspection of the features of an array for use in making quality decisions.

FIG. 1B is a flowchart providing a generalized overview of events (although somewhat more detailed than FIG. 1A) that may be automatically performed leading up to and carrying out visual inspection of arrays to determine the quality of array features, including events that have been automated according to the present invention.

FIG. 2A is a simplified illustration of a chemical array.

FIG. 2B shows a profile that is referred to for an explanation of morphological openings.

FIGS. 3A-3D are illustrations representing feature non-uniformities.

FIGS. 4A-4F illustrate granulometries to identify bright spots. These FIGS. are side views of three dimensional illustrations, e.g., the ellipses shown underneath (or above) the features 232 are disks, but may be other three-dimensional objects.

FIGS. 5A-5B illustrate the performance of operations known as morphological closings during a procedure to identify dark spots for dark spot level quantification.

FIG. 6A-6B illustrates a morphological opening, or more exactly, a “top hat” operation, used during identification and quantification of perimeter non-uniformities.

FIG. 7 is an abbreviated example of output metrics according to the present invention.

FIG. 8 is another abbreviated example of further output metrics according to the present invention.

FIG. 9 shows a very simplified, schematic representation of a very small portion of an image output as described herein.

FIG. 10 illustrates a typical computer system that may be employed in accordance with an embodiment of the present invention.

FIG. 11 shows a comparison of the pass/fail statistics between the human eye qualifications, and the system qualifications of the same microarrays.

FIG. 12 is a histogram that shows the distribution of quality scores of arrays failed by human eye inspection versus results from automatic inspection by the present system.

FIG. 13 is a histogram that shows the distribution of quality scores of array passed by human eye inspection versus results from automatic by the present system.

### DETAILED DESCRIPTION OF THE INVENTION

Before the present methods, systems and computer readable media are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “a defect” includes a plurality of such defects and reference to “the feature” includes reference to one or more features and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

### DEFINITIONS

In the present application, unless a contrary intention appears, the following terms refer to the indicated characteristics.

A “biopolymer” is a polymer of one or more types of repeating units. Biopolymers are typically found in biological systems and particularly include polysaccharides (such as carbohydrates), and peptides (which term is used to include polypeptides and proteins) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another.

A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides.. For example, a “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (for example, a single amino acid or nucleotide with two linking groups one or both of which may have removable protecting groups).

When one item is indicated as being “remote” from another, this is referenced that the two items are at least in different buildings, and may be at least one mile, ten miles, or at least one hundred miles apart.

“Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

A “processor” references any hardware and/or software combination which will perform the functions required of it. For example, any processor herein may be a programmable digital microprocessor such as available in the form of a mainframe, server, or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic or optical disk may carry the programming, and can be read by a suitable disk reader communicating with each processor at its corresponding station.

Reference to a singular item, includes the possibility that there are plural of the same items present.

“May” means optionally.

Methods recited herein may be carried out in any order of the recited events which is logically possible, as well as the recited order of events.

A “chemical array”, “array”, “microarray” or “bioarray” unless a contrary intention appears, includes any one-, two- or three-dimensional arrangement of addressable regions bearing a particular chemical moiety or moieties (for example, biopolymers such as polynucleotide sequences) associated with that region. An array is “addressable” in that it has multiple regions of different moieties (for example, different polynucleotide sequences) such that a region (a “feature” or “spot” of the array) at a particular predetermined location (an “address”) on the array will detect a particular target or class of targets (although a feature may incidentally detect non-targets of that feature). Array features are typically, but need not be, separated by intervening spaces.

Each feature, both before and after hybridization will ideally be uniform in shape and signal intensity as it is being examined. However manufacturing errors, poor quality control of manufacturing, poor experimental protocol during hybridization, or other error sources may produce arrays having at least a percentage of non-ideal features. One example of a non-ideal feature is exhibited by what is termed a “doughnut”, which generally refers to a dot or feature that is only filled circumferentially along the perimeter, with a blank or hole in the center, or a feature that is much brighter circumferentially along the perimeter than in the center of the feature or hole of the doughnut. “Crescents” are similar, but are less symmetrical around the perimeter of the feature and therefore take on more of a crescent shape than a doughnut shape. A “bright spot” is fairly self-explanatory, and refers to a region within the feature that is significantly brighter than the remainder of the feature. Bright spots may be of varying size (ranging from just a few pixels up to a majority of the area of the feature, up to as much as fifty percent in some cases) and number. Likewise, a “dark spot” is fairly self-explanatory, and refers to a region within the feature that is significantly less bright than the remainder of the feature. Dark spots may be of varying size, (ranging from just a few pixels up to a majority of the area of the feature up to as much as fifty percent in some cases) and number. Other partially formed or malformed features or manufacturing errors may also occur, such as irregular boundaries (perimeters) of the features; out of round features (when the features are intended to be circular), and others.

In the case of an array, the “target” will be referenced as a moiety in a mobile phase (typically fluid), to be detected by probes (“target probes”) which are bound to the substrate at the various regions. However, either of the “target” or “target probes” may be the one which is to be evaluated by the other (thus, either one could be an unknown mixture of polynucleotides to be evaluated by binding with the other). An “array layout” refers to one or more characteristics of the features, such as feature positioning on the substrate, one or more feature dimensions, and an indication of a moiety at a given location. “Hybridizing” and “binding”, with respect to polynucleotides, are used interchangeably. A “pulse jet” is a device which can dispense drops in the formation of an array. Pulse jets operate by delivering a pulse of pressure to liquid adjacent an outlet or orifice such that a drop will be dispensed therefrom (for example, by a piezoelectric or thermoelectric element positioned in a same chamber as the orifice).

A “subarray” is a subset of an overall array as presented on a multipack slide. Typically, a number of subarrays are laid out on a single slide and are separated by a greater spacing than the spacing that separates features or spots or dots. The terms “subarray” and “array” or “microarray” may be used interchangeably, depending upon the context. For example, in the situation where multiple arrays are laid out on a single slide, each array may be considered a subarray of the entirety of the layout, which could be considered an array made up of the subarrays, wherein each subarray may be an independent microarray, such as referred to in the present description, and wherein the array formed as a composite of such subarrays may be referred to as the “overall array”.

Any given substrate (e.g., slide) may carry one, two or more (e.g., many now have eight) arrays disposed on a front surface of the substrate. Depending upon the use, any or all of the arrays may be the same or different from one another and each may contain multiple spots or features. A typical array may contain more than ten, more than one hundred, more than one thousand more than ten thousand features, or even more than one hundred thousand features, in an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, or 20% of the total number of features).

Interfeature areas will typically (but not essentially) be present which do not carry any polynucleotide (or other biopolymer or chemical moiety of a type of which the features are composed). Such interfeature areas typically will be present where the arrays are formed by processes involving drop deposition of reagents but may not be present when, for example, photolithographic array fabrication processes are used,. It will be appreciated though, that the interfeature areas, when present, could be of various sizes and configurations.

Each array may cover an area of less than 100 cm², or even less than 50 cm², 10 cm² or 1 cm². In many embodiments, the substrate carrying the one or more arrays will be shaped generally as a rectangular solid (although other shapes are possible; for example, some manufacturers are currently working on flexible substrates), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, substrate 10 may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulse jets of either polynucleotide precursor units (such as monomers) in the case of in situ fabrication, or the previously obtained polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. As already mentioned, these references are incorporated herein by reference. Other drop deposition methods can be used for fabrication, as previously described herein. Also, instead of drop deposition methods, photolithographic array fabrication methods may be used. Interfeature areas need not be present particularly when the arrays are made by photolithographic methods.

Following receipt by a user of an array made by an array manufacturer, it will typically be exposed to a sample (for example, a fluorescently labeled polynucleotide or protein containing sample) and the array then read. Reading of the array may be accomplished by illuminating the array and reading the location and intensity of resulting fluorescence at multiple regions on each feature of the array,. For example, a scanner may be used for this purpose which is similar to the AGILENT MICROARRAY SCANNER manufactured by Agilent Technologies, Palo Alto, CA. Other suitable apparatus and methods are described in U.S. Pat. Nos. 6,406,849, 6,371,370, and U.S. patent applications Ser. No. 10/087447 “Reading Dry Chemical Arrays Through The Substrate” by Corson et al., and Ser. No. 09/846,125 “Reading Multi-Featured Arrays” by Dorsel et al. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,251,685, U.S. Pat. No. 6,221,583 and elsewhere). A result obtained from the reading followed by a method of the present invention may be used in that form or may be further processed to generate a result such as that obtained by forming conclusions based on the pattern read from the array (such as whether or not a particular target sequence may have been present in the sample, or whether or not a pattern indicates a particular condition of an organism from which the sample came). A result of the reading (whether further processed or not) may be forwarded (such as by communication) to a remote location if desired, and received there for further use (such as further processing). Further, results from quality inspection of an array prior to sending it to an end user may be forwarded (such as by communication) to a remote location if desired, and received there for further use (such as determining whether to alter a specification for pass criteria).

The present invention provides methods, systems and computer readable media for automatically inspecting the visual appearance of chemical arrays and for determining whether the quality of an array is sufficient for use, based on the visual appearance of the array and features contained therein. These automated techniques are faster than the current manual approaches being used, reduce the cost of inspection and reduce bias error.

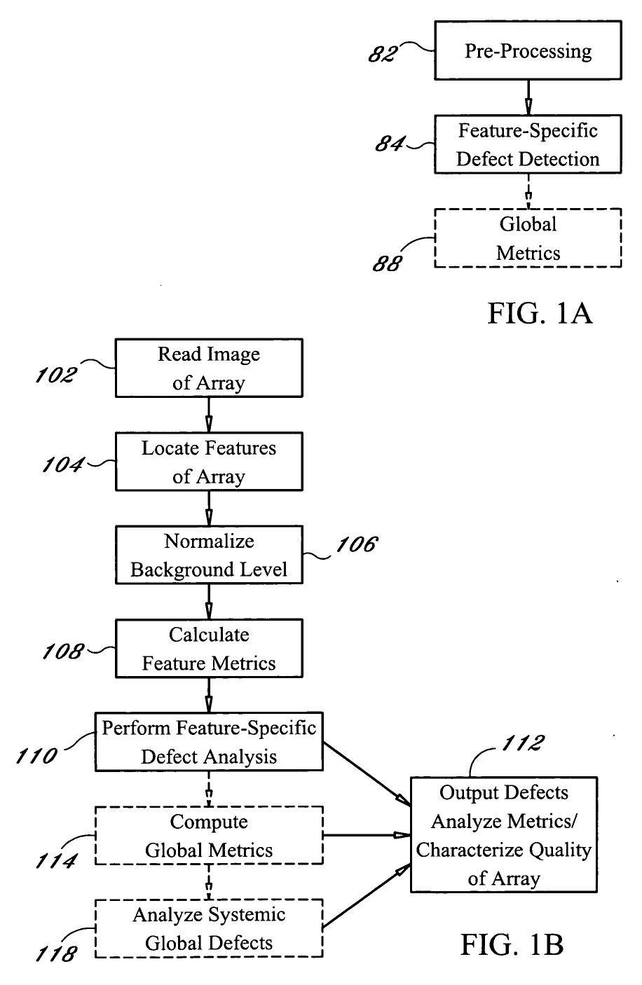

FIG. 1A is a flow chart indicating automated processes that may be carried out for automatic visual inspection of the features of an array for use in making quality decisions. Pre-processing 82 is carried out in order to identify the locations of features on a substrate, so that further analysis can take place based on those locations. For each feature to be inspected, an automatic analysis of feature-specific defects may then be carried out. Such analysis may include quantifications regarding defects such as bright spots, dark spots, donuts, crescents, etc., which are described in more detail below. Some measurements may be used in making a determination as to whether or not a feature is defective. Measurements such as size, roundness, or other geometrically based measurements may be automatically made. Further optionally, global metrics 88 may be computed that effect multiple features, for example nozzle metrics, gradients, etc.

FIG. 1B is a flowchart providing a generalized overview of events (although somewhat more detailed than FIG. 1A) that may be automatically performed leading up to and carrying out visual inspection of arrays to determine the quality of array features, including events that have been automated according to the present invention. At event 102, an image of a chemical array having been scanned previously to produce the image is read into the system. The image may have been produced by any of the techniques described above. For exemplary purposes, assume that the image is a TIFF image produced by scanning a chemical array. For exemplary purposes, assume that the chemical array is a microarray having features as described above, although it is to be noted that the present invention is not limited to microarrays, but may be applied to various other chemical arrays. Nor is the invention limited to the reading of TIFF images, as other image formats may be inputted and read.

At event 104, the features on the array in the image are located. This typically includes finding the centroids of the features, although other grid/coordinate identifying features may alternatively or additionally be used to identify where the features are located. Currently existing software/systems for feature extraction may be used for this event, such as the Agilent Feature Extraction Software (Agilent Technologies, Inc., Palo Alto, California) or other available feature extraction products. Further detailed information regarding techniques for feature extraction is described in co-pending, commonly assigned application Ser. No. 10/449,175 filed May 30, 2003 and titled “Feature Extraction Methods and Systems”. Application Ser. No. 10/449,175 is hereby incorporated herein, in its entirety, by reference thereto. The present system may incorporate software, firmware and/or hardware for carrying out events 102 and 104, or may use separate software, firmware and/or hardware to carry out events 102 and 104 and then input the results to the present system.

The input received from the feature extraction processing may be received in the form of a text file, for example. Based upon the input received from event 104 (such as centroid locations or other coordinate identifiers of the features), the present system locates the features on the array image.

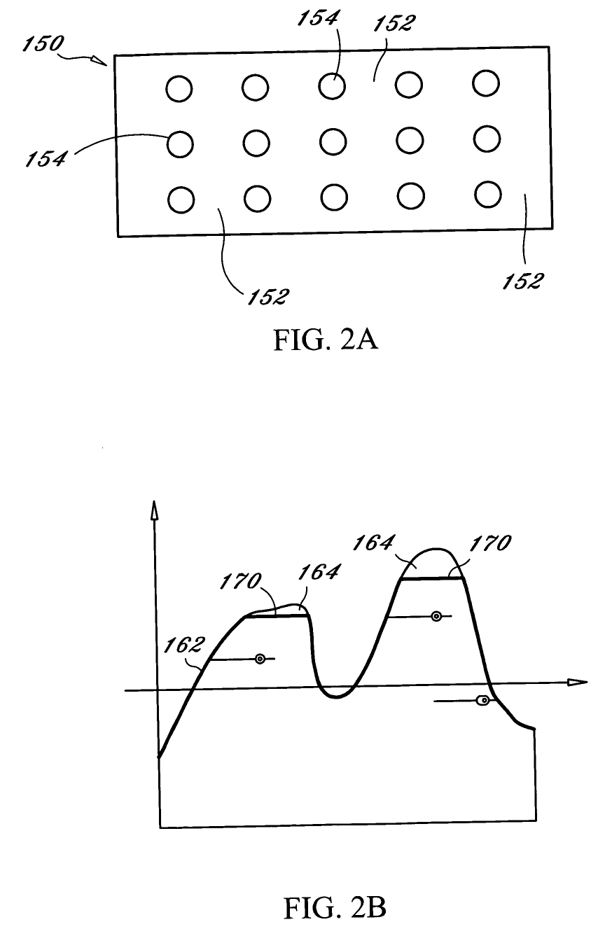

At event 106 the system processes the image to normalize background level using a procedure referred to as “top hat” to estimate the background level in the image and then subtract the background level from the image. A goal of background level normalization is to take out extraneous signals that are not attributable to those signals produced by the features. For example, referring to the image 150 shown in FIG. 2A, the system endeavors to render the background 152 (that surrounds features 154) black so that it is consistent throughout the image. Prior to performing the background level normalization, the system initially provides the image as a single channel (color) image and may then convert the single color image to grayscale for further processing. Alternatively, the further processing may be carried out on the single color image. Currently, for a two-channel system that uses a red and a green channel, the system typically uses the red channel, after conversion to grayscale. However, the present invention is not limited to this analysis, as noted. Additionally, for images that are originally multi-channel (multi-color), the processes described herein may be carried out on each channel (color) based on the respective single color image, or a grayscale transformation of each.

Background level normalization processing begins with processing the image to estimate the brightness/intensity levels of the background of the image and then subtracting this background from the original image, thereby setting the background in the resulting image to black. This estimation may be performed by carrying out a morphological opening process on the image. Morphological opening processes, or “top hat” procedures are well-known and described throughout the literature, e.g., see Serra et al., “An Overview of Morphological Filtering”, Circuits, Systems and Signal Processing, Vol. 11, No. 1, pp. 47-108, 1992, which is hereby incorporated herein, in its entirety, by reference thereto.

FIG. 2B schematically illustrates a morphological openings procedure showing areas 164 under the curve 162 in which disks would not fit having been clipped 170. In order to provide a binary mask of the features 154, a morphological opening procedure may be performed using a structuring element of a size predetermined not to fit within an intensity peak formed by any possible feature of the array. The size of such structuring element will of course be dependent upon the size of the features to be inspected, and will vary as the size of the features on an array varies. In a typical example, a structural element of 40 pixels by 40 pixels dimension was used to perform the opening for background normalization.

After clipping peaks based on the opening processing, an image that is substantially black is left remaining which can be considered an excellent estimate of image background level at every pixel. The intensity values of the substantially black image are then subtracted from the intensity values of the image as it existed prior to carrying out the opening process, on a pixel-by-corresponding pixel level to render the background intensity to have a value of essentially zero. By effectively setting the intensity values of the background at essentially zero, this makes comparison and thresholding of values within the features much easier, since they may be directly compared without having to account for variations in background levels.

After completion of processing in event 106 features 154 are plainly delineated by a black background and for each feature, metrics may be calculated to characterized the overall size and shape of the feature at event 108.

It should be noted here that this event is optional, and, when performed, need not be carried out prior to detection of feature-specific defects or measurement of global defects, as confirmed by the example of FIG. 1A where measurements 86 are optionally performed after detection 84 of feature specific defects. It should further be noted that not all features are necessarily processed, as the system can be preconfigured for automatic analysis of only a certain type of feature. For example, the operator may be interested only in the quality of a certain control type of feature, and the system being set to such, will process only those features identified with the preset control type.

The “size” of a feature, for example may be computed by the area of the feature computed as total number of pixels that are bounded by the perimeter of the feature. The feature sizes may be reported as raw data and/or lower and/or upper threshold sizes may be preset, such that if the size of any particular feature considered exceeds a preset threshold, it is immediately, automatically rejected as being of poor quality. Likewise, a minimum (or maximum) brightness level threshold may be preset such that when brightness metrics are computed, each feature that has a brightness less than (or greater than, respectively) the preset threshold level of brightness or intensity, is flagged or determined to fail the quality inspection. Additionally, the shape of each feature examined may be computed. For features that are expected to be round (such as features 154 in FIG. 2A, for example), a roundness metric to characterize such features may be computed. For example, roundness may be calculated by extracting the outline/perimeter of the feature and measuring the furthest distance L from a point on the perimeter to the centroid of the feature (wherein the centroid is already given from processing performed in event 104), and also by measuring the shortest distance S from the centroid to a point on the perimeter. Feature elongation may then be calculated as:
If S=0 and L=0: FeatureElongation=0;
Otherwise, If S=0: FeatureElongation=100;
Otherwise, FeatureElongation=MIN(100,100×((L−S)/S) (1)
From this, the roundness level can be computed as:
RoundnessLevel=100−FeatureElongation (2)

If S=L the feature elongation, as calculated, is zero and the feature is determined to be perfectly round; accordingly the roundness level is calculated to be 100. As with previously described metrics, in this case, a predefined roundness limit can be set, such that any feature that is calculated to have a roundness value of less than the predefined limit or threshold can be automatically flagged or automatically determined to fail the quality inspection. Alternatively or additionally, the raw roundness scores can be reported, which can later be used to form composite scores, when combined with other metrics, by which it may be determined whether or not a particular feature fails or passes, or an overall array fails or passes. Further, this is only one example of scoring for roundness, and the present invention is not limited to such particular calculations, as those of ordinary skill in the art could fashion a different, but likely equally effective, shape or roundness score after a reading of the present disclosure.

Feature specific defect analysis is performed at event 110. Not only might systematic errors induce the production of some (or all) features of inferior quality, but the nature of the production process makes it impossible to ensure perfect uniformity and quality of all features. For example, for an array having features that are printed, such as a bioarray containing oligomeric features, a drop of liquid is deposited in the area where each feature is to be defined. Those drops, when deposited, spread across the surface of the substrate onto which they are deposited, and typically do not form perfect circles at the perimeters of spreading. Thus, the concentration of the liquid is uneven around the perimeter, and may even be uneven within the area of the feature. Further, one oligomer at a time may be built up on the features, which requires repeated depositions on the same features, one oligomer at a time. This requires many deposition layers on each feature. Each time a drop is deposited on the feature, there is potential for the location of deposition to be slightly different. Even though the system is programmed to deposit the drops repeatedly exactly at the center of each feature, it is clearly statistically impossible to do so. The slight variations in the locations where the drops are deposited are also another source of error that may result in a lack of perfect consistency or quality in a resulting feature or features. Further, processing errors may result in locations or spots having significantly more target built up then the surrounding areas of the feature. This results in relatively more or less, respectively, target hybridization occurring at those locations and spots, which in turn, results in bright spots or dark spots, respectively. Bright and/or dark spots can occur anywhere within a feature and can take on any shape. Thus, bright spot and dark spot detection is generic to all types of anomalies/morphology changes in a feature, since any change or inconsistency in the uniformity of a feature will appear either brighter or darker than the overall consistent brightness of the feature where an anomaly is not located.

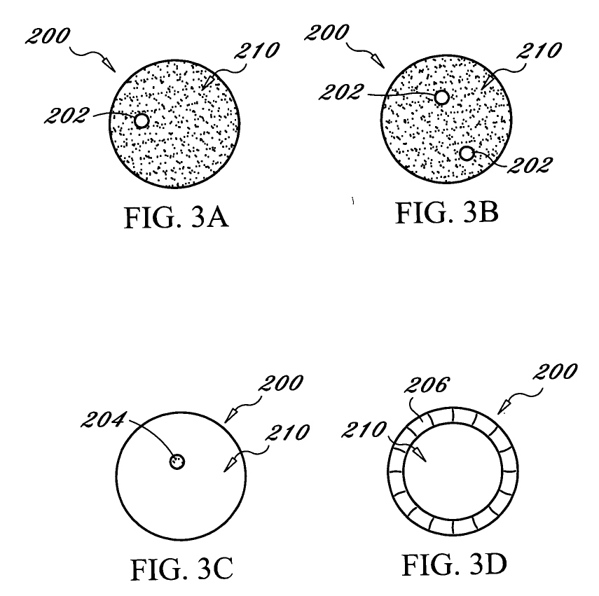

Examples of such non-uniformities include, but are not limited to bright spots, dark spots, donuts, crescents and dimples. FIGS. 3A-3D show examples of these non-uniformities. FIG. 3A is a schematic representation of a feature that, when analyzed, is determined to have a bright spot 202 relative to the remainder 210 of the feature which, in this case, has substantially uniform brightness.

FIG. 3B is similar to FIG. 3A except that this feature 200 contains two bright spots 202. Thus when analyzed by the present system, the feature 200 in FIG. 3A may score a relatively lower “bright spot level” value compared to the bright spot level calculated for the feature 200 in FIG. 3B. Alternative scales for relative scoring of bright spot scores may be employed, e.g., feature 200 in FIG. 3A may score a “1” on a relative bright spot scale, while feature 200 in FIG. 3B may score a “2” in the relative bright spot level category, where the bright spot level scale numerically represents the relative bright spot levels of the features having been analyzed, and increases as a function of increased relative brightness of the spots, relative to the substantially uniform brightness of the remainder of the feature. Other relative scoring schemes may be employed additionally or alternatively.

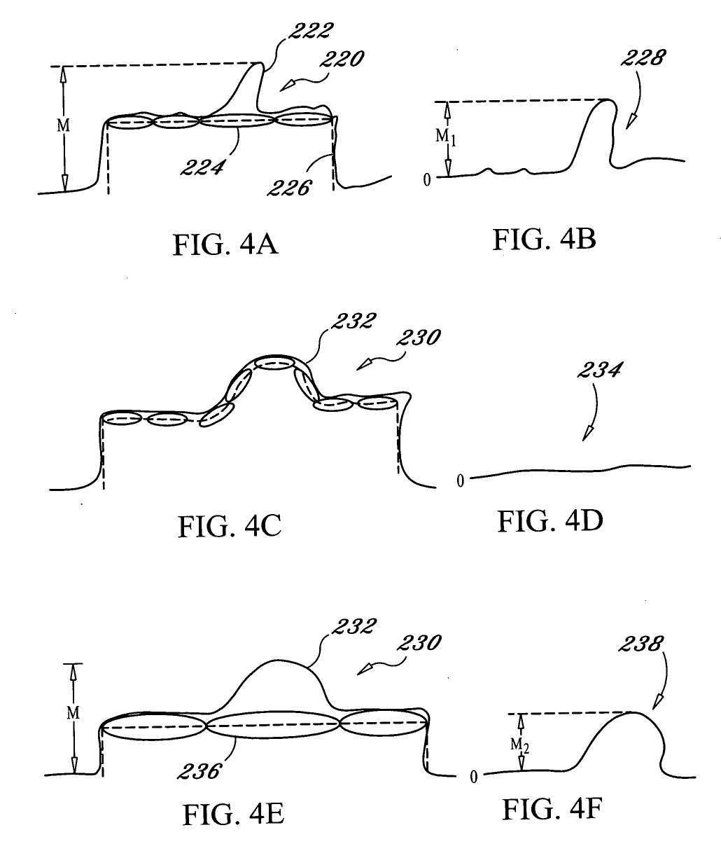

Typically, the system may calculate bright spot levels using morphological openings processes. Since bright spots may be of varying sizes, however, openings of varying sizes may need to be applied, and this type of approach is referred to as granulometries. A detailed discussion of processing using granulometries can be found in Vincent, “Granulometries and Opening Trees”, Fundameta Informaticae 41 (2000) 57-90, which is incorporated herein, in its entirety, by reference thereto. For example, FIG. 4A represents a brightness/intensity profile 220 of a feature that has a relatively small bright spot represented by the relatively narrow peak 222. Because the size (area) of the bright spot is relatively small, the peak 222 will be relatively narrow regardless of the intensity differential between the bright spot and the remainder of the feature. In this instance, a relatively small disk or square size may be used to perform the opening, as indicated by disks or squares 224 in FIG. 4A.

A granulometric residue is then determined, e.g., the intensity values of the resultant opening 226 defined by the dashed lines in FIG. 4A are then subtracted from the intensity values from the original image profile to give the intensity/brightness profile 228 shown in FIG. 4B. Next, the maximum intensity value m₁ of profile 228 is resultant after performance of the opening as described, is determined, for comparison with the maximum intensity or brightness value M from the original profile 220 prior to performance of the opening, to determine a bright spot level or metric, as will be described in further detail following.

Because the areas of the bright spots on a feature can vary significantly, multiple granulometric residues are generally computed to determine a bright spot level. FIG. 4C illustrates the ineffectiveness of using a structuring element 224 that is small enough to pass into a peak 232 formed by a large bright spot in a feature, the intensity profile 230 of which is shown in FIG. 4C. In such an instance, the granulometric residue 234 does not detect the peak 232 as can be seen in FIG. 4D. However, when a larger structuring element 236 is used, as represented in FIG. 4E, the resultant granulometric residue profile 238 does register the peak 232 and can be used to measure brightness of the bright spot.

Typically then, at least two granulometric residues are computed for analysis of bright spots because of the variation in sizes of bright spots that can be expected. Those pixels located over the border of the feature are set to a zero brightness or intensity value on each of the granulometric residue profiles. The maximum intensity/brightness value M of the original image profile is computed, as described above, as well as the maximum intensity values from each of the granulometric residues, e.g., m₁, m₂, . . . , mₙ. For a series of n granulometric residues having been computed, a bright spot level value may be computed as follows:
BrightSpotLevel=100×max(m₁, m₂, . . . , mₙ)/M (3)

The number of different sized structuring elements that are used, and thus the number of granulometric residues that are computed are dependent on the size of the features being inspected, and particularly the range of sizes of bright spots that can be expected. In a typical example, while inspecting features with an average size of about 15-20 pixels, two different sized structuring elements were used to compute two granulometric residues, respectively. For example, the smaller structuring element used was a square of three pixels by three pixels and the larger structuring element used was a disk having a radius of three pixels. In this specific case, the numerator of the quotient in equation (3) above becomes whichever is the higher value of m₁ and m₂ from residue 1 and residue 2 respectively.

A preset threshold for BrightSpotLevel may be set in the system so that if the computed bright spot level exceeds the threshold, the feature being inspected is flagged as having a bright spot. For example, a default threshold may be 20%. However, this threshold is editable by an operator or system administrator and may be set to a level desired.

In order to distinguish “bright spots” from donuts or crescents, which can be thought of as specifically located bright spots around the perimeters of features, but which are desired to be specifically categorized and distinguished from bright spots that occur inside of the body of the feature, the system may perform one or more “erosion” procedures, prior to carrying out the granulometric procedures described above. An erosion is performed by removing a perimeter of the feature, such as by removing each outer pixel of the feature all the way around the perimeter of the feature. Thus, the erosion is tantamount to trimming the perimeter of the feature from the feature, wherein the trimmed border or perimeter is one pixel' worth of signal at each location around the perimeter. Multiple erosions may be performed, and the number of erosions that are performed will be dependent upon the size of the features being inspected, as well as possibly the dimensions of donuts and crescents that are to be expected. For the example described above where two granulometric residues were computed, two erosion procedures were carried out, effectively an area bounded by two pixels around the perimeter of the feature.

The system may also be configured to identify spots that have less brightness (i.e., “dark spots”) than a substantially uniform brightness that is typically seen in a high quality feature. Thus when the example of FIG. 3C is analyzed, that feature may score a relatively lower “dark spot level” value compared to a dark spot level or value calculated for a feature having a relatively larger dark spot. Alternative scales for relative scoring of dark spot scores may be employed, e.g., feature 200 in FIG. 3C may score a “1” on a relative dark spot scale, where the dark spot level scale numerically represents the relative dark spot levels of the extracted features having been analyzed, and increases as a function of decreased relative brightness of the spots, relative to the substantially uniform brightness (or darkness) of the remainder of the feature.

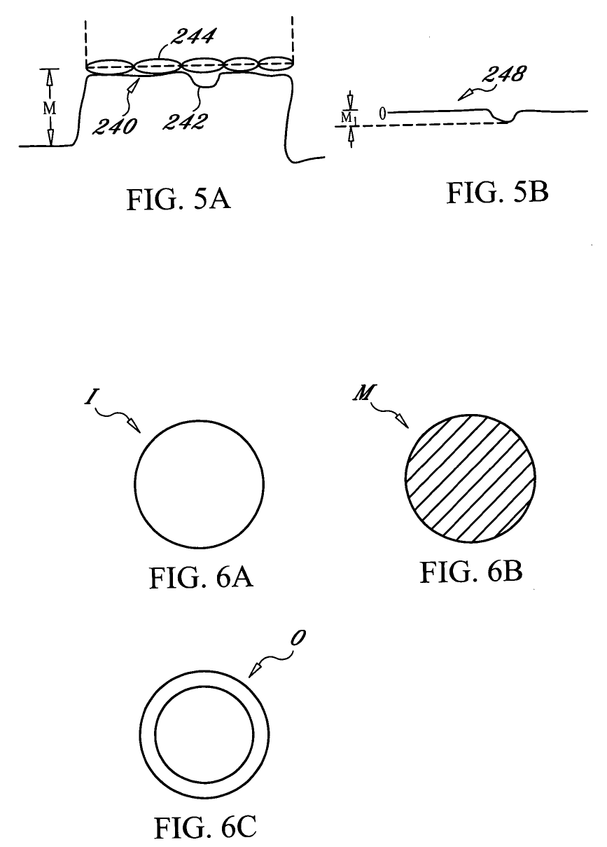

Typically, the system may calculate dark spot levels somewhat similarly to computation of bright spot levels, but where closing operations are performed rather than opening operations. A closing operation or “morphological closing” is very similar to a morphological opening except that, in the case of a closing, a structuring element (e.g., a disk or square or other predefined element) having a predefined size, is used to approach an intensity profile of the image from above the intensity profile, and then “filling up” the intensity valleys into which the structuring element would not fit. FIG. 5A schematically illustrates fitting of structuring elements 244 from above an intensity profile 240 of a feature in performance of a closing process. In this representation, the area of the curve 240 defined by valley 242, into which structuring element 244 will not fit, is clipped, as shown by the resulting residue intensity profile 248 after processing by morphological closing. Thus, this operation is analogous to a morphological opening operation discussed above, only performed from above, on a “valley”, as opposed to from below on a “hill” or peak.

While successive closings using structuring elements of varying sizes may be used (e.g., granulometries), this will be dependent upon the variation in sizes of dark spots that inspections are inspected to encounter, which may also be a function of the size of the features being inspected. For the example discussed above, dark spot sizes were found not to vary as much in size as bright spot sizes, and therefore only one closing was performed using only one size structuring element. Of course, the present invention is not limited to performance of only one opening operation per feature to characterize bright spots, as should be readily apparent from the discussion above.

Thus, a generalized description of computing for dark spot levels is described here. A small opening (e.g., about three pixels by three pixels) may be performed on an image to filter out noise somewhat. A dark spot level is then computed on the opened image, referred to as image I. A small closing (e.g., about three pixels by three pixels)may next be performed, resulting in image I1. The values of images I and I1 are then set to zero in locations outside of a previously computed mask overlying the feature being analyzed. Next the maximum value of image I (M0) is computed and a new image K (where K=I−I1) is computed. In other words, for each pixel p of K, K(p)=I1 (p)−I(p). The maximum value of K (i.e., M1) is next computed and a dark spot level may then be computed as: DarkSpotLevel=100×(M1/M0). If multiple closings are used than an image has to be computed for each closing. For example, if two closings are used, then an image I2 also is computed, as the opening size of 5 pixels by 5 pixels for example, of I1. The maximum value M2 of I2−I1, is computed and then the maximum between the previously computed dark spot level and another dark spot level calculated as DarkSpotLevel=100×(M2/M1) is calculated.

As noted, in an example described above, dark spot sizes were not expected to vary as greatly as bright spot sizes and so only one closing operation was carried out per feature, using a square of three pixels by three pixels as a structuring element to determine the dark spot level of each feature.

A preset threshold for DarkSpotLevel may be set in the system so that if the computed dark spot level exceeds the threshold, the feature being inspected is flagged as having a bright spot. For example, a default threshold may be 20. However, this threshold is editable by an operator or system administrator and may be set to a level desired.

A non-uniformity referred to as a donut has characteristics where the non-uniformity is generally circular in shape, located on the periphery of the feature, and is generally co-centric with the centroid of the feature. A crescent is similar to a donut, but is less symmetrical, with the defect being more shaped like a crescent as opposed to a fairly symmetrical ring. A crescent will also be located on the periphery of a feature. FIG. 3D illustrates an example of a donut type non-uniformity, where the donut 206 is brighter than the remainder of the feature 210 that may be otherwise substantially uniform in brightness. Based on the mask (referred to above) of the feature, a fixed ring is computed that has a fixed width about the perimeter (e.g., typically about 2 pixels) of the feature.

The fixed width perimeter is then analyzed to look for bright spot pixels specifically over the region by thresholding the first top hat residue (resulting from a morphological opening, and intersecting the result with the fixed-width perimeter ring.

During formation of a feature, layers of deposition that spread out at significantly inconsistent radii from the center of depositions of the drops may be one cause of the formation of a donut or crescent. This is not the only cause, however the present system is not concerned with the causation of the donuts/crescents but rather with identifying donuts, as well as other non-uniformities, and quantifying, such as by scoring, these non-unifornities so that a decision can be made based upon such scores as to the quality of the features on an array. Thus, even after extracting the best portion of each feature, one or more extracted portions may still include one or more bright or dark spots or a portion of a donut remaining, for example, since manufacturing variables can lead to different feature morphologies, as described above. The present system measures the level of manufacturing variable impact, by quantifying degrees of imperfections in the features.

To identify defects or non-uniformities on the periphery of a feature, e.g. donuts, crescents or the like, an original image I of the feature is first computed (FIG. 6A). A mask M (FIG. 6B) is then computed that covers the feature image I. Using the mask M of the feature, an erosion is performed to erode the periphery of the mask M by a width of the desired fixed width of an outline to be calculated. Outline 0 is then calculated by subtracting that portion of image I covered by the eroded mask, leaving only the perimeter portion or outline 0 of the feature image as shown in FIG. 6C. A top hat operation is performed on image I based on an opening with a predefined sized structuring element (e.g., 3 pixels by 3 pixels size), and a threshold is set to keep all pixels having a value greater than the threshold value above the maximum value of the portion of image I covered by the eroded mask M. An intersection of the results of the thresholding with the pixel values in outline 0 is next performed to provide a binary image of all pixels in outline 0 having brightness levels that are significantly brighter than the brightness of the feature in the area inside the outline area, i.e., significantly brighter than they would be if the feature had uniform brightness. The number of significantly brighter pixels in outline 0 is counted and divided by the total number of pixels in outline 0 to give a level of donut-ness.

A predefined threshold value may be set to determine when further processing should be carried out to determine whether a feature is considered to have a donut defect. In the example described above, this threshold was set to 20. Thus, if m/M≧threshold (i.e., in the example, if m/M ≧0.20, ), then the further analysis of the feature is carried out to determine whether the feature is considered to have a donut. However, this threshold may also be varied, if desired, such as if it is considered that a higher or lower threshold would be more appropriate for the features being inspected, or as depending upon the constraints for quality required by a particular customer, or the like.

When m/M is computed to be greater than the predetermined threshold, the system then analyzes each of the pixels within the predefined region and determines how many of those pixels have intensity values greater than the predetermined threshold, in a manner as described above. The percentage of the pixels in the predefined region (i.e., outline 0) that score intensity value/M threshold is the donut level or “level of donut-ness” characterizing the feature. The system may have a second preset threshold (threshold 2) to define the percentage of area of outline) above which a significant donut problem is considered to exist, such that if the donut level exceeds threshold 2, then the feature is flagged as being determined to have a donut. The amount or level of donut-ness, of course, is dependent upon by how much the percentage exceeds threshold 2. In the example described above, threshold 2 was set to 15% or 0.15. Threshold 2 is editable independent of threshold and may be varied for similar reasons to those described above with regard to the threshold, for example.

Further alternatively, or additionally, the donut level may be outputted as computed above, and may be used for a subsequent determination as to whether a donut exists, and/or in combination with other metrics/values to determine a composite score as to the quality of a feature and/or to global quality of an array for example.

As noted earlier, the analyses described may be performed in each band/channel (separately, as also noted above) and is carried out with respect to each extracted feature or a designated subset of each extracted feature, resulting in numerical outputs characterizing the level of defects in each feature analyzed, to include defects such as donuts, etc, at each location.

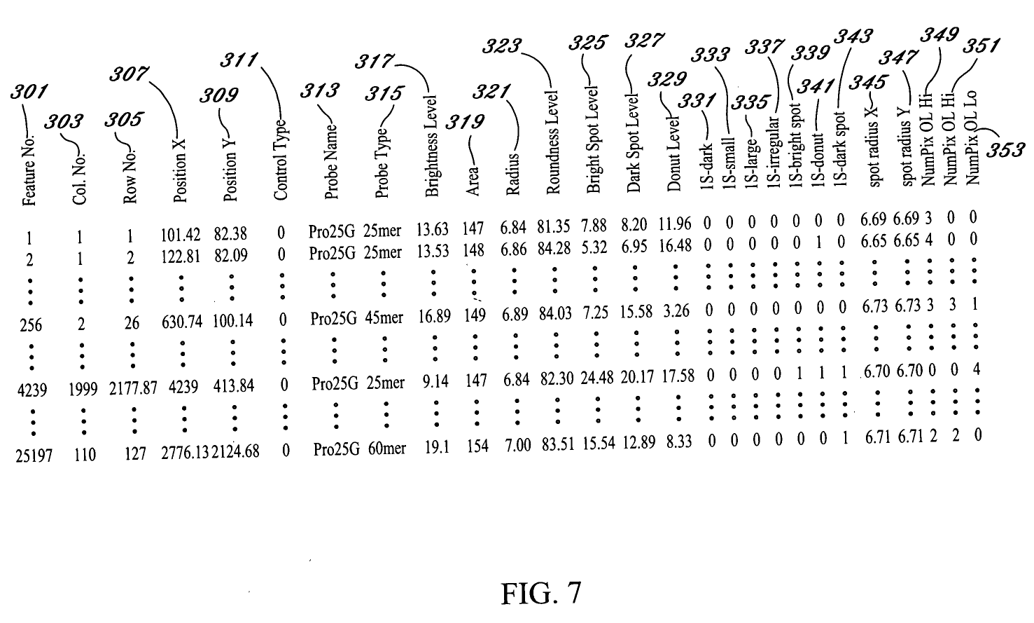

FIG. 7 shows a portion of exemplary data that may be outputted by the present system at event 112. For brevity and exemplary purposes, data for only five features is shown. In practice, it is not unusual for tens of thousands of lines of output data to be outputted to score tens of thousands of features that may be present on an array. Entry 301 tracks the feature number according to a pre-designed order in which the features are considered during analysis. Columns 303 and 305 display the column and row positions of the feature being reported upon, where the columns and rows of the array on which the feature resides are numbered in ascending order with integers.

Columns 307 and 309 describe the coordinates of the centroid of the feature, which may be determined by feature extraction software, as noted above, and inputted to the present system. Column 311 indicates the control type used, wherein control type 0 signifies probes used for experimental data, control type−1 signifies probes used for background algorithms, and control type 1 is used for other control probes such as spike-ins, etc. Columns 313 and 315 identify the probe name and probe type contained on the feature in that line, which may also be provided as input from a feature extraction software or system.

Column 317 reports the overall brightness level of the feature that was analyzed, indicating the maximum brightness value of the feature image after background normalization, over the mask of the feature. Feature brightness may be normalized to values between 0.0 and 100.0, e.g., a feature of maximum brightness is assigned a brightness value of 100.0.

Columns 319 and 321 report the area and radius of the feature, as computed by the system. As noted above, area and radius measurements are typically made during the feature extractions phase of processing, which may be integrated with the present system, or the results of which may be inputted to the present system. Features that are not round are assumed to be round for purposes of radius calculation, and such radius is calculated by taking the square root of the calculation of area divided by pi.

Column 325 outputs a “roundness level” metric that is capable of indicating when a feature is significantly out of round, as described earlier. In the example shown, the roundness level of each feature reported in FIG. 7 is of sufficient quality if the threshold is a roundness level of 80%, for example, as the roundness level of each feature reported in FIG. 7 is greater than 80%. The value of is_dark 331 is indicated with a “1” if the feature being reported on is below a predefined brightness threshold, thereby identifying the feature as a dark feature. Otherwise, the value is set to “0”. The value of is_small 333 is indicated with a “1’ if the feature being reported on is below a predefined lower size threshold, thereby identifying the feature as a small feature. Otherwise, the value is set to “0”. The value of is_large 335 is indicated with a “1’ if the feature being reported on is above a predefined upper size threshold, thereby identifying the feature as a large feature. Otherwise, the value is set to “0”. The value of is_irregular 337 is indicated with a “1’ if the feature being reported on has a roundness level that exceeds a predefined threshold from perfectly round, thereby identifying the feature as irregular. Otherwise, the value is set to “0”. The value of is_brightspot 339 is indicated with a “1’ if the system determines one or more bright spots present in the feature in a manner as described above, thereby identifying the feature to have a bright spot. Otherwise, the value is set to “0”. The value of is_donut 341 is indicated with a “1’ if the feature being reported on is determined to have a donut as determined by the techniques described above, thereby identifying the feature as having a donut. A feature having a significant crescent would also be identified here with a value of “1”. Otherwise, the value is set to “0”. The value of is_darkspot 343 is indicated with a “1’ if the system determines the feature to have one or more significant dark spots, using the techniques described above. Otherwise, the value is set to “0“. The values for spotraduisX 345, spotradiusY 347, gNumPix0 LHi 349, rNumPix 0 LHi 351 and gNumPix 0 LHi 353 are metrics that are determined by feature extraction software associated with the present system and are not use for quality scoring according to the methods described herein.

Accordingly the system provides a comprehensive, objectively scored description of each feature on the array being analyzed. From the output, each feature is described as to size, level of roundness, overall brightness level and levels of non-uniformity including bright spot level, dark spot level, and donut level.

The ability to automatically and systematically quantify the metrics described above provides the ability to objectively rate the quality of features on a microarray and to eliminate the human bias errors that are introduced by human quality control inspection of features. For example, continuing with the example referred to throughout this description, threshold levels for “bright spot level”, “dark spot level” and “donut level” were preset to 25, 15 and 15, respectively. Thus, one way of automatically qualifying features that are inspected is to pass any feature that scores a bright spot level less than or equal to 25, a dark spot level less than or equal to 15 and a donut level less than or equal to 15. In contrast to the present techniques, human inspections are subjective, and based upon the perceptions of the particular human inspector that is doing the viewing of the features. Thus, if a portion of a feature “appears relatively dark” or is perceived to be relatively dark, the inspector may note this. The end result is pass or fail, but with no objective standards for coming to the conclusion. Further, the perceptions of the inspectors can and do vary from inspector to inspector. Perceptions of the same inspector may even vary from feature to feature or array to array, based upon many different human factors, including, but not limited to, fatigue, boredom, day of the week, time of day, how the inspector feels, etc. By objectively scoring well-defined characteristics of each feature, the present system provides for an objective determination of the quality of an array. Further, the “pass level” for what is determined to be an acceptable array may be varied, depending upon the needs of the user. Thus, there is not just one subjective method of determining pass/fail, but an adjustable objective mechanism that can slide the pass/fail threshold to differing levels of quality, depending upon the needs or uses for the particular array(s) being examined.

For example, as each feature is quality scored for categories of dark spot level, bright spot level and donut level, as already noted, a user may pre-qualify what quality score is acceptable to the human eye, with regard to each of the categories. This pre-qualification serves to define the pass and fail criteria for qualification of a feature by the system as “good” or “bad”. The user can obtain an array's overall score by summarizing using descriptive statistics that can be used to qualify (pass) the array or fail the array. Such descriptive statistics may include, but are not limited to, mode or median score calculated from the scores of all of the features of the array.

The level of quality can be increased by increasing the stringency of the pre-set user scores used for the pass threshold. Conversely, if the use for the arrays can allow for somewhat lower quality standards, the level of quality that will be considered passing can be lowered by decreasing the stringency of the pre-set user scores. Thus the system provides the pre-set scores, that can be further processed (interactively as provided by allowing user input through a user interface, if desired) to determine the end result as to whether an array passes or fails.

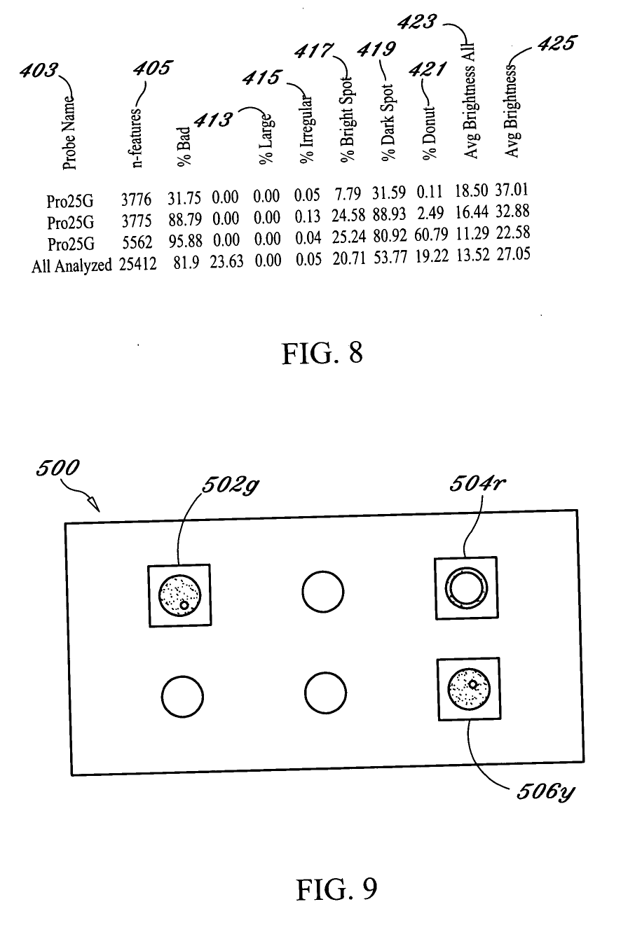

Further, global metrics may optionally be computed at event 114, and a global report may be provided with respect to each feature/type of feature at event 112. The metrics in the global report indicate scores reflecting the number of features of a particular probe type that were scored by the metric. FIG. 8 shows an example of global output figures that may be compiled and outputted by the present invention. Not all global metrics have been represented here for the purposes of simplicity and meeting drawing requirements. In row 1, for example, the type of probe named Pro 25 G_onG3PDH570_10Ts was selected (displayed in abbreviated form under the ProbeName column header 403) for display of the quality metrics in composite form. Column 405 shows that there were 3,776 features containing the probe named Pro25G_onG3PDH570_10Ts on the particular array being considered. Based upon the objective pass criteria set (as described above) the system determines the percentage of “bad” or failed features and displays the percentage under column 407. Similarly, numbers for the percentage of dark features among those 3,776 features considered are displayed under column 409. A dark feature is typically labeled as such after initial computation of brightness of a feature is determined to be less that a preset minimally acceptable brightness level. After being flagged as a “dark feature”, no further metrics are typically carried out on this feature.

The percentage of small spots are reported under column 411 and the percentage of large spots are reported under column 413. These percentages may be computed based on a comparison of the feature sizes with set thresholds for feature sizes that are considered to be too large and too small, respectively. Column 415 reports a percentage of the features that are considered to be irregular. A feature may be labeled irregular when it exceeds a preset threshold for roundness level (i.e., less than a preset roundness level).

Percentages of the features selected in the row for bright spots, dark spots and donuts are reported under column headers 417, 419 and 421 respectively. These statistics report on the percentages of all features inspected that were identified to have a bright spot, a dark spot, or a donut, respectively.

Columns 423 and 425 report figures for average brightness ALL and average brightness, respectively. Average brightness ALL is a computation of the average brightness for all features of the type reported on (e.g., same control type, same number of mers, etc.) that were not initially rejected as being too dark. Average brightness is similarly calculated, but excludes from the calculation not only all features that were considered to be too dark, but all features that were considered to be too large or too small or irregular.

The system is not limited to reporting the global metrics described above. The system can (and typically does) output further objective global data such as statistical characterizations of the global metrics, which may include, but are not limited to: standard deviation with regard to brightness; average brightness of features that passed; average brightness of features that failed; average feature area of features in the selected row; average feature area for all features in the array; standard deviation with regard to either of the foregoing area statistics; average area of selected features that passed; standard deviation with regard to areas of features that passed; average radius of all and/or the selected features; standard deviations of radius statistics; average radius of selected features that passed; standard deviation with regard to average radius of features that passed; average roundness, standard deviation with regard to roundness; average roundness of features that passed, and standard deviation with regard to the same; etc.

The objectively determined metrics allow not only the determination of whether an array passes or fails, but to what degree or amount that the array passed or failed by, in contrast to human inspection, which merely subjectively determines whether an array passes or fails, based only on subjective perception, but no objective standards. The present techniques allow customized standards to be set for various users and uses of arrays. Since some uses will require a stricter quality standard then others, pass thresholds can be varied, depending on use requirements, in the manners described above. Each feature gets a score for each of the metrics described (e.g., bright spot level, dark spot level, donut level, roundness level, radius, area, small, large, irregular). A specification for a particular user can create a criteria for passing or failing for each metric that is measured for each feature. Alternatively, only some or maybe even only one metric may be specified with regard to a pass/fail threshold, for example.

Each feature is then scored, based upon the specification being applied, wherein each feature is determined to either pass or fail. From this data, a global score may then be compiled by the system to determine the percentage of failed features (i.e., % bad 407). Further, features may be scored for each type or classification of probe. Based upon the end user's criteria for the percentage of features that pass, the system then determines whether the array passes or fails. Thus, at event 112, the system outputs the metrics/defect metrics that objectively characterize the features of the array being analyzed. Based upon the quantitative characterizations of the features, and any pass/fail specifications that have been set, the system may also determine whether the array passes or fails, and may output this or other characterization of the quality of the array.

Still further optionally, the system may analyze systemically-induced global defects at event 118 and output results of computations that objectively score the degree that such defects appear within an array. For example, several types of systemically-induced defects may be the result of different types of nozzle problems or inconsistencies that may occur during the deposition phase of the features on the array. One such defect occurs when one or more nozzles is clogged or partially clogged. In this case, there may be a repetitive defect occurring with every X columns for the entire column, where X is an integer characterizing the number of nozzles that are used in the apparatus that is depositing the array. For example, for a writer using twenty nozzles, where the first nozzle is partially clogged, the first, twenty-first, forty-first, etc. columns of the array will typically appear darker than the remainder of the columns. Another typical defect is where the first set of columns (e.g., first twenty columns, when the writer uses twenty nozzles) deposited by the writer are significantly damaged compared to the rest of the array. Yet another nozzle-related systemic defect may be intermittent, where some columns are damaged, but there does not appear to be a specific pattern to those columns that are damaged relative to the overall array.

To analyze for repetitive, nozzle-related defects (e.g., such as the example where there is a repeating sequence of damaged columns, e.g., every twentieth column), the average feature brightness dᵢ is computed for a particular feature type, where the average is computed over every column produced by one particular nozzle (e.g., I, i+X, i+2X. . . . For example, when X=20, 1^{st}, 21^{st}, 41^{st} . . . columns). These computations are repeated for each series of columns, i.e., for each 1≦i≦X. For each average brightness calculated, an average brightness of all of the same feature type located in columns not considered, i.e., in columns outside of those currently considered for the calculation of dᵢ is calculated as dᵢ^{o}. A level of defect for columns I, i+X, i+2X may then be calculated as:

$$LevelOfDefect = 100 \times {max}_{i} ( ( {ⅆ}_{i}^{o} - {ⅆ}_{i} ) / {ⅆ}_{i}^{o} ) \qquad ( 5 )$$

An example of feature types, is that one computation may compute average feature brightness for 60-mer features, for example. Thus, for arrays having more than one type of feature, this analysis may be repeated for the other types (e.g., if 45-mer features and 25-mer features are also included on the array, for example). The system may be preset with a pass/fail threshold for the level of defect calculated in equation (5) above, such that if any nozzle i produces columns of any of the feature types calculated to have a level of defect that exceeds the threshold value, then the array is automatically failed for quality. This threshold may be edited, similar to other thresholds described above. Alternatively, level of defect scores may be considered with other scores to automatically determine whether an array passes or fails based upon a composite score. Further alternatively, level of defect scores may be outputted for human determination as to whether the array is to be passed or failed. Also, level of defect scores may be outputted in addition to either of the first two alternatives mentioned above.

To analyze for a potential defect where first set of columns (e.g., first twenty columns, when the writer uses twenty nozzles) deposited by the writer are significantly damaged, a similar approach is used, with the difference being that the average brightness (for a feature type) over the entire first set of columns is compared to the average brightness of that type of feature over the rest of the array. As with the repeating sequence analysis, only features that have not been previously rejected are considered for systemic level of defect analysis here.

Thresholds, automatic determinations, manual determinations may be made similar to that discussed above with regard to the repeating sequence analysis.

For random problems, an average brightness of a single column may be computed for a particular feature type and compared to an average brightness of the same type of feature in all other columns. As with the repeating sequence analysis, only features that have not been previously rejected are considered for systemic level of defect analysis here. Thresholds, automatic determinations, manual determinations may be made similar to that discussed above with regard to the repeating sequence analysis.

Additionally, the system may output an image of the array with overlays of symbols on features that were found to fail regarding one or another metric having had a threshold specified. Further, an overlay may also be displayed to indicate features that passed. FIG. 9 shows a very simplified, schematic representation 500 of a very small portion (i.e., only six features) of an image output, as described, which may be stored as a .shp (ESRI Shape file, a vector format created by the Environmental System Research Institute file, see http://www.leadtools.com/SDK/Vector/Formats/Vector-Format-SHP.htm), for example. In this example, a green box or outline 502g surrounds, or is overlaid around features identified as containing one or more dark spots. 504r is a red indicator indicating that the feature highlighted scored for donut level. 506y is a yellow indicator identifying a feature having at least one bright spot. The remaining features were found to be substantially uniform and are not associated with any kind of highlight or indicator in this example.

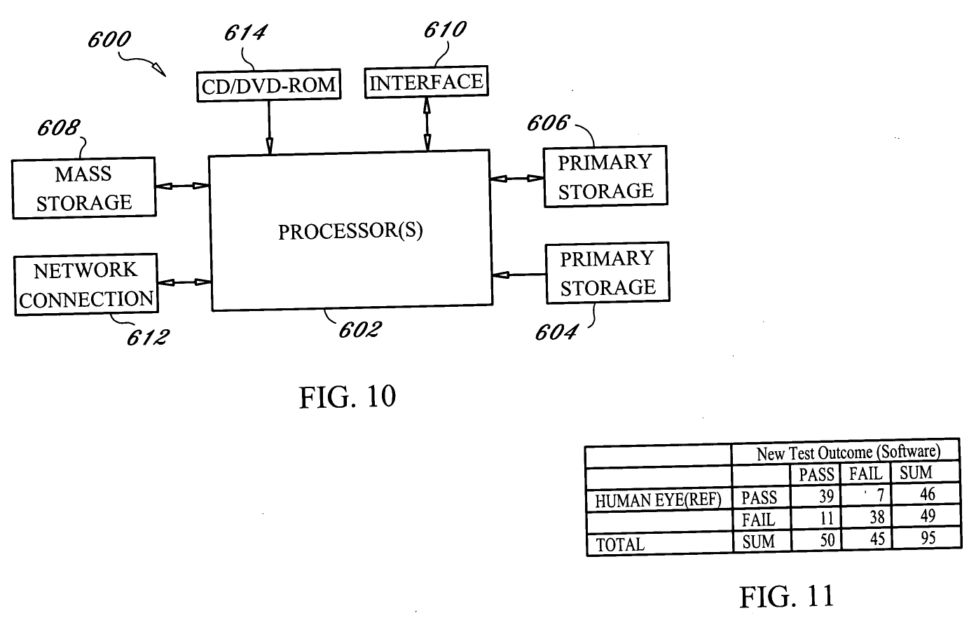

FIG. 10 illustrates a typical computer system in accordance with an embodiment of the present invention. The computer system 600 includes any number of processors 602 (also referred to as central processing units, or CPUs) that are coupled to storage devices including primary storage 606 (typically a random access memory, or RAM), primary storage 604 (typically a read only memory, or ROM). As is well known in the art, primary storage 604 acts to transfer data and instructions uni-directionally to the CPU and primary storage 606 is used typically to transfer data and instructions in a bi-directional manner Both of these primary storage devices may include any suitable computer-readable media such as those described above. A mass storage device 608 is also coupled bi-directionally to CPU 602 and provides additional data storage capacity and may include any of the computer-readable media described above. Mass storage device 608 may be used to store programs, data and the like and is typically a secondary storage medium such as a hard disk that is slower than primary storage. It will be appreciated that the information retained within the mass storage device 608, may, in appropriate cases, be incorporated in standard fashion as part of primary storage 606 as virtual memory. A specific mass storage device such as a DVD-ROM and/or CD-ROM 614 may also pass data uni-directionally to the CPU.

CPU 602 is also coupled to an interface 610 that includes one or more input/output devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to a computer or telecommunications network using a network connection as shown generally at 612. With such a network connection, it is contemplated that the CPU might receive information from the network, or might output information to the network in the course of performing the above-described method steps. The above-described devices and materials will be familiar to those of skill in the computer hardware and software arts.

The hardware elements described above may implement the instructions of multiple software modules for performing the operations of this invention. For example, instructions for computing donut levels may be stored on mass storage device 608 or 614 and executed on CPU 608 in conjunction with primary memory 606.

In addition, embodiments of the present invention further relate to computer readable media or computer program products that include program instructions and/or data (including data structures) for performing various computer-implemented operations. The media and program instructions may be those specially designed and constructed for the purposes of the present invention, or they may be of the kind well known and available to those having skill in the computer software arts. Examples of computer-readable media include, but are not limited to, magnetic media such as hard disks, floppy disks, and magnetic tape; optical media such as CD-ROM, CDRW, DVD-ROM, or DVD-RW disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

### EXAMPLE

The following example is are put forth so as to provide those of ordinary skill in the art with a complete disclosure and description of how to make and use the present invention, and are not intended to limit the scope of what the inventors regard as their invention nor are they intended to represent that the example below is all or the only analysis performed. Efforts have been made to ensure accuracy with respect to numbers used (e.g. statistical data, quantities, etc.) but some experimental errors and deviations should be accounted for.

Two sets of microarrays were analyzed by the system that had previously been scored by human visual inspection. One set of the microarrays was failed by the human inspectors and the other set was passed by the human inspectors. Based on the analyses, if the percentage of failed 60mer features (i.e., the composite score % bad 407, with respect to 60mer features on an array) was greater than 10%, then that particular array was declared failed by the system. If the percentage of failed 60mer features for a particular array was between 5% and 10% the array was placed in a category for further review. If the percentage of failed 60mer features for an array was less than 5%, then that particular array was declared passed by the system.

For one hundred and two arrays analyzed, FIG. 11 shows a comparison of the pass/fail statistics between the human eye qualifications, and the system qualifications of the same microarrays. Seven microarrays were placed in the category for further review, so they were not considered in the comparison. For ninety-five arrays sampled, the system and human inspection agreed on passing thirty-nine arrays as well as on failing thirty-eight arrays. There was disagreement between the two types of inspection with regard to eighteen arrays. The system achieved greater than 80 percent accuracy (i.e.82.1053%) and was considered to be a successful alternative to human eye inspection.

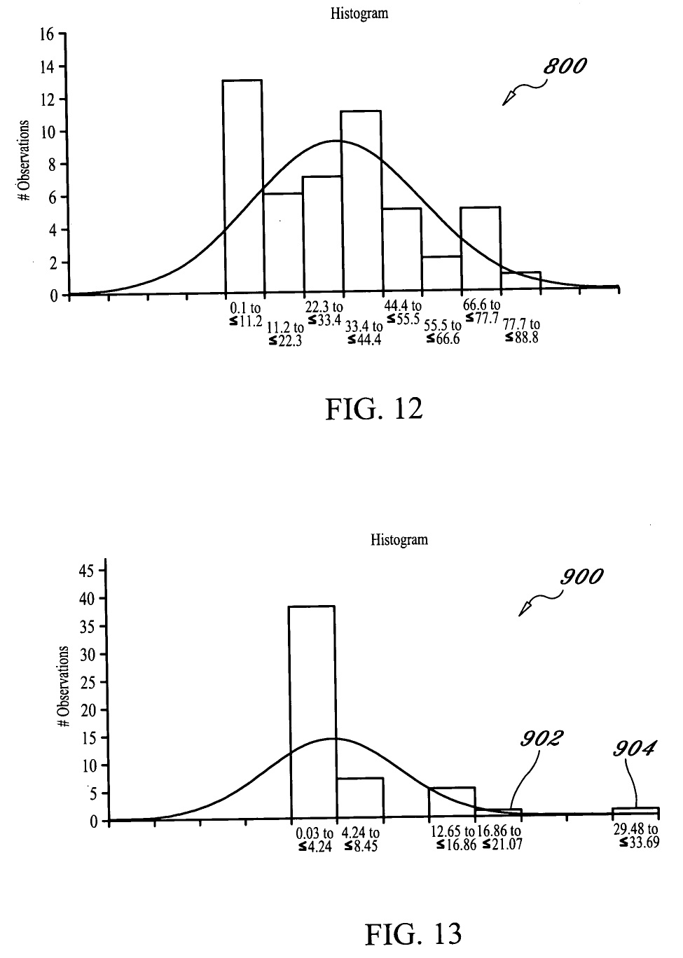

FIG. 12 is a histogram 800 that shows the distribution of quality scores against numbers of observations within the number of arrays that were failed by human eye inspection. The #Observations on the vertical scale is the number of microarrays considered, where each microarray is termed an observation. The quality score ranges all the way from 0.1 to 88.8 on the horizontal scale. The mean value of the quality scoring was 31.74. This type of measurement would not be possible by the human eye inspection method, since all failed arrays are merely labeled failed or bad, with no gradation as to the degree of badness.

Referring now to FIG. 13, a histogram 900 that shows the distribution of quality scores against numbers of observations within the number of arrays that were passed by human eye inspection is displayed. The #Observations on the vertical scale is the number of microarrays considered, where each microarray is termed an observation. The quality score ranges all the way from 0.1 to 88.8 on the horizontal scale. The mean value of the quality scoring was 3.8442. This type of measurement would not be possible by the human eye inspection method, since all passed arrays are merely labeled failed or bad, with no gradation as to the degree of goodness (or badness).

The present system provides gradation and accomplishes this by the automated methods described, whereas human eye inspection only gives a qualitative assessment of an array as being “good” or “bad”. Overall, the data in FIGS. 12 and 13 confirms that the system is able to automatically distinguish between arrays that have been passed by human eye inspection and arrays that have been failed by human eye inspection.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. A system for automatically inspecting a chemical array, said system comprising:
a processor adapted to receive a digitized image of the chemical array; and
at least one of hardware, software and firmware adapted to quantify at least one visual characteristic of a feature on the chemical array that contributes to uniformity of the visualization of the feature.

2. The system of claim 1, further comprising at least one output device to which said processor outputs quantifications resultant from quantifying said at least one visual characteristic.

3. The system of claim 1, wherein said at least one visual characteristic comprises feature roundness, and said at least one of hardware, software and firmware includes and algorithm to calculate a roundness level of a feature.

4. The system of claim 1, wherein said at least one visual characteristic comprises bright spot identification, and said at least one of hardware, software and firmware includes an algorithm for quantifying a bright spot level.

5. The system of claim 4, wherein said algorithm applies morphological opening for said quantifying a bright spot level.

6. The system of claim 5, wherein said at least one algorithm applies granulometries for said quantifying a bright spot level.

7. The system of claim 1, wherein said at least one visual characteristic comprises dark spot identification, and said at least one of hardware, software and firmware includes an algorithm for quantifying a dark spot level.

8. The system of claim 7, wherein said algorithm applies morphological closing for said quantifying a dark spot level.

9. The system of claim 1, wherein said at least one visual characteristic comprises identification of non-uniformity around a perimeter of the feature, and said at least one of hardware, software and firmware includes an algorithm for quantifying a level of non-uniformity around the perimeter of the feature.

10. The system of claim 9, wherein said non-uniformity around a perimeter of the feature comprises a donut defect, and said level of non-uniformity comprises donut level.

11. The system of claim 10, wherein said algorithm applies morphological opening for quantifying said donut level.

12. The system of claim 1, further comprising at least one algorithm for computing whether the feature passes or fails a quality inspection, based upon at least one of the quantified visual characteristics.

13. The system of claim 1, wherein said at least one of hardware, software and firmware adapted to quantify at least one visual characteristic of a feature on the chemical array is adapted to quantify said at least one visual characteristic for a plurality of features on the chemical array, said system further comprising at least one algorithm for computing whether the array passes or fails a quality inspection, based upon at least one of the quantified visual characteristics considered over a plurality of said plurality of features.

14. The system of claim 13, wherein a plurality of visual characteristics are quantified for each of said plurality of features, and wherein said system comprises at least one algorithm for computing whether the array passes or fails a quality inspection, based upon a plurality of said plurality of quantified visual characteristics considered over a plurality of said plurality of features.

15. The system of claim 1, wherein a plurality of visual characteristics are quantified for said feature, and wherein said system comprises at least one algorithm for computing whether the feature passes or fails a quality inspection, based upon a plurality of said plurality of quantified visual characteristics.

16. A method for automatically quantifying a visual characteristic of a chemical array, said method comprising the steps of:
receiving a digitized image of a chemical array having at least one feature;
automatically quantifying at least one visual characteristic of a feature on the chemical array that contributes to uniformity of the visualization of the feature; and
outputting a result based on said automatically quantifying at least one visual characteristic of a feature.

17. The method of claim 16, wherein said result comprises at least one quantified metric representative of a visual characteristic of the feature.

18. The method of claim 16, wherein said result includes an automatically determined conclusion as to whether the feature passed or failed a quality inspection.

19. The method of claim 16, wherein said at least one visual characteristic comprises feature roundness, and wherein said automatically quantifying includes calculating a roundness level of the feature.

20. The method of claim 16, wherein said at least one visual characteristic comprises bright spot identification, and wherein said automatically quantifying includes calculating a bright spot level of the feature.

21. The method of claim 20, wherein said calculating a bright spot level includes computing at least one morphological openings procedure.

22. The method of claim 20, wherein said calculating a bright spot level comprises use of granulometries to calculate multiple openings procedures.

23. The method of claim 16, wherein said at least one visual characteristic comprises dark spot identification, and wherein said automatically quantifying includes calculating a dark spot level of the feature.

24. The method of claim 23, wherein said calculating a dark spot level includes computing at least one morphological closings procedure.

25. The method of claim 16, wherein said at least one visual characteristic comprises identification of non-uniformity around a perimeter of the feature, and wherein said automatically quantifying includes calculating a level of non-uniformity around the perimeter of the feature.

26. The method of claim 25, wherein said non-uniformity around a perimeter of the feature comprises a donut defect, and wherein said calculating a level of non-uniformity comprises calculating a donut level.

27. The method of claim 26, wherein said calculating a donut level includes computing at least one morphological openings procedure.

28. The method of claim 16, further comprising automatically computing whether the feature passes or fails a quality inspection, based upon at least one of the quantified visual characteristics.

29. The method of claim 28, wherein said outputting a result includes outputting an indication of whether the feature passes or fails based upon said automatically computing whether the feature passes or fails.

30. The method of claim 16, wherein the chemical array includes multiple features, and said automatically quantifying comprises automatically quantifying at least one visual characteristic of a plurality of said multiple features.

31. The method of claim 30, further comprising computing whether the array passes or fails a quality inspection, based upon at least one of the quantified visual characteristics considered over a plurality of said plurality of features.

32. The method of claim 31, wherein a plurality of visual characteristics are quantified for each of said plurality of features, and wherein said computing whether the array passes or fails is based upon a plurality of said plurality of quantified visual characteristics considered over a plurality of said plurality of features.

33. The method of claim 16, wherein a plurality of visual characteristics are quantified for said feature, and wherein said result includes a computation determining whether the feature passes or fails a quality inspection, based upon a plurality of said plurality of quantified visual characteristics.

34. The method of claim 16, further comprising identifying a location of each said feature on said array prior to said automatically quantifying with regard to said feature respectively.

35. The method of claim 34, wherein said locating is based upon a centroid of each said feature, respectively.

36. The method of claim 16, wherein the chemical array is a multi-channel array, said method further comprising extracting a single channel representing a digitized visualization of the array, wherein said automatically quantifying is carried out with respect to said single channel.

37. The method of claim 36, further comprising converting said single channel to grayscale prior to said automatically quantifying.

38. The method of claim 16, further comprising normalizing a background level of the array prior to said automatically quantifying, wherein said background level characterizes a brightness of the array that is extraneous to brightness of said at least one feature.
